(19) United States
(12) Patent Application Publication
(10) Pub. No.: US 2015/0281702 A1
(43) Pub. Date: Oct. 1, 2015

(54) METHOD FOR ENCODING AND DECODING COLOR SIGNALS

(71) Applicant: HON HAI PRECISION INDUSTRY CO., LTD., New Taipei (TW)

(72) Inventor: AN-PANG CHANG, New Taipei (TW)

(21) Appl. No.: 14/642,357

(22) Filed: Mar. 9, 2015

(30) Foreign Application Priority Data
Mar. 31, 2014 (TW) 103111984

(51) Int. Cl. H04N 19/186; H04N 19/70; H04N 19/174

(52) U.S. Cl. CPC H04N 19/186; H04N 19/174; H04N 19/70

(57) ABSTRACT

The present disclosure is a method for encoding and decoding color signals. One aspect of the disclosure includes: inputting a encoded color signal; decomposing the encoded color signal in a color coordinate system to a plurality of color coordinate values; decomposing each of the plurality of the color coordinate values to a set of color intensity codes; converting the set of color intensity codes to a digitized color value; and outputting the digitized color code value. Under the method for encoding and decoding color signals the amount of information greatly increased after using the method of the present disclosure.

### FIELD

The subject matter herein generally relates to a method for encoding and decoding color signals.

### BACKGROUND

There are a number of modulation techniques for transferring communication signals, such as amplitude modulation (AM), Frequency Modulation (FM), Frequency-shift Keying (FSK), Quadrature Amplitude Modulation (QAM), Orthogonal Frequency Division Multiplexing (OFDM) and the like.

### BRIEF DESCRIPTION OF THE DRAWINGS

Implementations of the present technology will now be described, by way of example only, with reference to the attached figures, wherein:

FIG. 1 is a flowchart of a method for decoding color signals of one embodiment of the present disclosure.

FIG. 2 is a flowchart of a method for encoding color signals of one embodiment of the present disclosure.

FIG. 3 is a diagrammatic view of the red green blue (RGB) coordinate system.

FIG. 4 is a diagrammatic view of composing the plurality of color coordinate values in the color coordinate system of FIG. 3 to the encoded color signal of FIG. 2.

FIG. 5 is a diagrammatic view of composing one or more digits of the set of superposition codes to the plurality of color coordinate values of FIG. 2.

FIG. 6 is a diagrammatic view of another embodiment of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

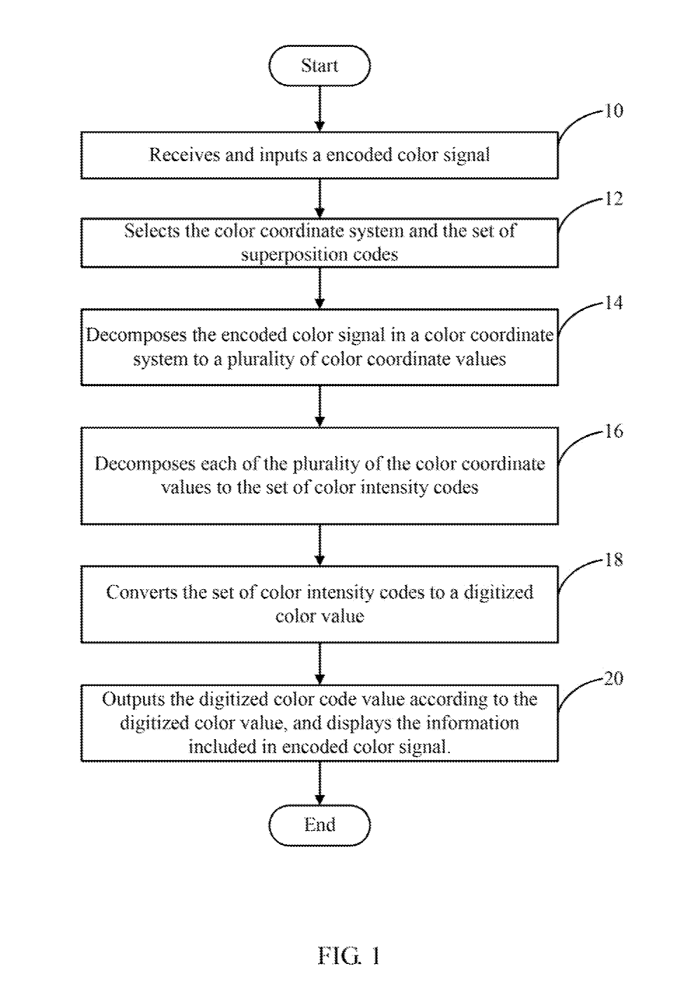

FIG. 1 illustrates a flowchart of a method for decoding color signals of one embodiment of the present disclosure. FIG. 1 illustrates a flowchart in accordance with an example embodiment. A method for decoding color signals is provided by way of example, as there are a variety of ways to carry out the method. The method for decoding color signals described below can be carried out using the configurations illustrated in FIG. 1, for example, and various elements of these figures are referenced in explaining method for decoding color signals. In FIG. 1 each block represents one or more processes, methods, or subroutines carried out in the voice-recognition method. Additionally, the illustrated order of blocks is by example only and the order of the blocks can change. The method for decoding color signals can begin at block 10.

At block 10, a sensor of a device for encoding receives and inputs an encoded color signal. In the present embodiment, the encoded color signal is the communication signal to be transferred, and the encoded color signal is obtained in accordance with a color coordinate system and a set of superposition codes. The color coordinate system and the set of superposition codes are predetermined and defined by an user. The encoded color signal comprises a matrix of a plurality of pixels, each pixel represents different communication of information by different colors. The color of each dot of the matrix is obtained in accordance with the set of superposition codes composed and overlaid in the color coordinate system.

At block 12, a device for decoding selects the color coordinate system of block 202 and the set of superposition codes of the block 204. In the present embodiment, the color coordinate system is RGB color coordinate system, and the set of superposition codes is {1, 2, 4, 8, 16, 32}, the type of color coordinate system, the set of superposition codes and the correspondence between the RGB color coordinate system and the set of superposition codes can be previously stored in a database or memory in a receiving, or be transmitted together with the encoded color signal to the receiver.

At block 14, a filter of the devices for decoding decomposes the encoded color signal in a color coordinate system to a plurality of color coordinate values, and each color coordinate value corresponds to each pixel of the encoded color signal. For example. the color coordinate value corresponds to the first pixel is (R:G:B)=(11,62,19).

At block 16, the devices for decoding decomposes each of the plurality of the color coordinate values to the set of color intensity codes, wherein the summation of the set of color intensity codes corresponds to each of the plurality of the color coordinate values, and each digit of the set of the color intensity codes corresponds to one of the digits of the set of superposition codes. For example, the coordinate value of R axis of the first pixel is 11, and the coordinate value of R axis 11 is added by the three digits 1, 2, 8 of the set of superposition codes {1, 2, 4, 8, 16, 32}, the coordinate value of G axis of the first pixel is 62, and the coordinate value of G axis 62 is sum of the three digits 2, 4, 8, 16, 32 of the set of superposition codes {1, 2, 4, 8, 16, 32}, the coordinate value of B axis of the first pixel is 19, and the coordinate value of B axis 19 is sum of the three digits 1, 2, 16 of the set of superposition codes {1, 2, 4, 8, 16, 32}. So the set of color intensity codes corresponding to the coordinate value of B axis of the first pixel is {1, 2, 8}, the set of color intensity codes corresponding to the coordinate value of G axis of the first pixel is {2, 4, 8, 16, 32}, the set of color intensity codes corresponding to the coordinate value of B axis of the first pixel is {1, 2, 16}.

At block 18, the devices for decoding converts the set of color intensity codes to a digitized color value, wherein converting the set of color intensity codes to a digitized color value comprises binary converting each digit of the set of the color intensity codes and converting the sum of each digit of the set of the color intensity to the codes digitized color value. For example, when the set of superposition codes is {1, 2, 4, 8}, the digitized color value corresponding to the set of color intensity codes { } is 0000, the digitized color value corresponding to the set of color intensity codes {1} is 0001, the digitized color value corresponding to the set of color intensity codes {2} is 0010, the digitized color value corresponding to the set of color intensity codes {1, 2} is 0011, the digitized color value corresponding to the set of color intensity codes {4} is 0100, the digitized color value corresponding to the set of color intensity codes {1, 4} is 0101, the digitized color value corresponding to the set of color intensity codes {2, 4} is 0110, the digitized color value corresponding to the set of color intensity codes {1, 2, 4} is 0111, the digitized color value corresponding to the set of color intensity codes {8} is 1000, the digitized color value corresponding to the set of color intensity codes {1, 8} is 1001, the digitized color value corresponding to the set of color intensity codes {2, 8} is 1010, the digitized color value corresponding to the set of color intensity codes {1, 2, 8} is 1011, the digitized color value corresponding to the set of color intensity codes {4, 8} is 1100, the digitized color value corresponding to the set of color intensity codes {1, 4, 8} is 1101, the digitized color value corresponding to the set of color intensity codes {2, 4, 8} is 1110, the digitized color value corresponding to the set of color intensity codes {1, 2, 4, 8} is 1111.

At block 20, the devices for decoding outputs the digitized color code value according to the digitized color value, and displays the information included in encoded color signal.

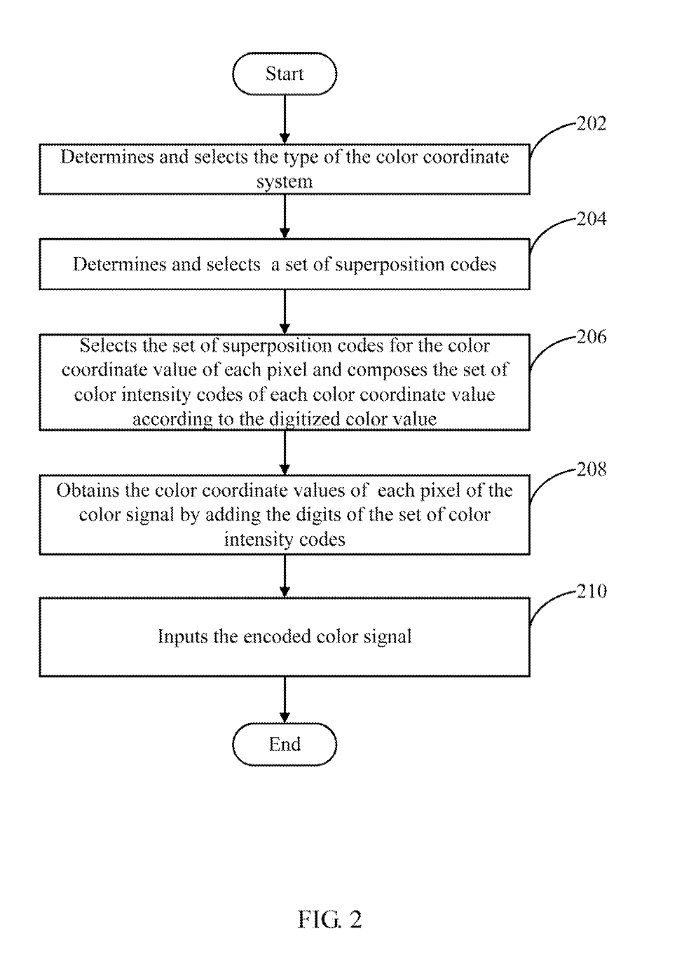

FIG. 2 illustrates a flowchart of a method for encoding color signals of one embodiment of the present disclosure. The specific methods of the set of superposition codes composed and overlaid in the color coordinate system are as follows.

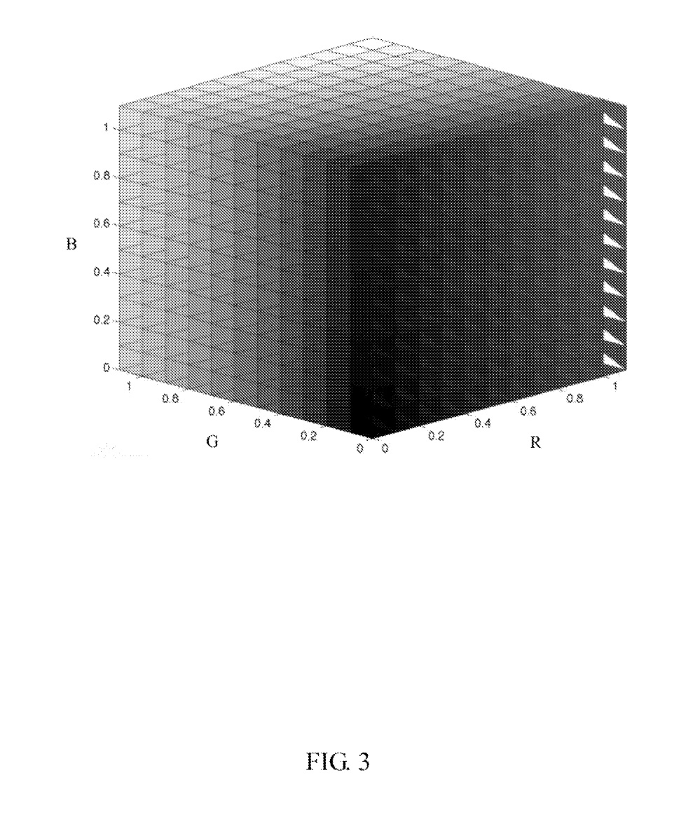

At block 202, the device for encoding determines and selects the type of the color coordinate system. Many different color coordinate systems can be selected, for example, the red green blue (RGB) coordinate system or other International Commission on Illumination (CIE) coordinate system. In the present embodiment, the color coordinate system is the RGB coordinate system (see FIG. 3). The RGB coordinate system or the RGB color space, is any additive color space based on the RGB color model. A particular RGB color space is defined by the three colors of the red, green, and blue additive primaries, and can produce any color that is defined by those primary colors. In the RGB coordinate system, each color represents the three variables: the intensity of red (the coordinate value of R axis), the intensity of green (the coordinate value of G axis) and the intensity of blue (the coordinate value of B axis).

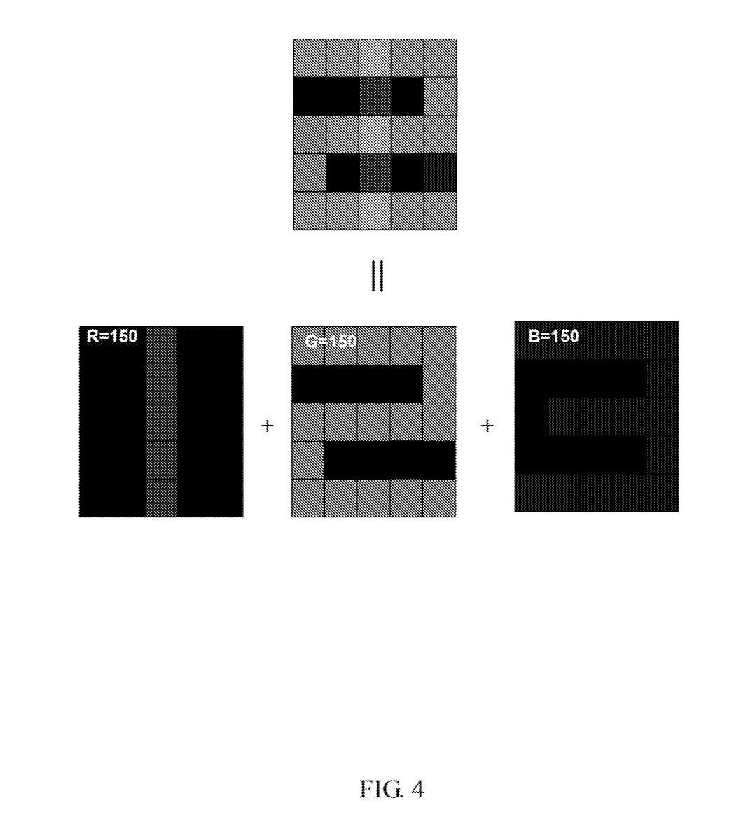

The RGB color coordinate system can be easily understood by thinking of it as “all possible colors” that can be made from three colors of red, green and blue. Zero intensity for each component gives the darkest color (no light, considered black), and full intensity of each gives a white; the quality of this white depends on the nature of the primary light sources, but if they are properly balanced, the result is a neutral white matching the white point of the system. When the intensities for all the components are the same, the result is a shade of gray, darker or lighter depending on the intensity. When the intensities are different, the result is a colorized hue, more or less saturated depending on the difference of the strongest and weakest of the intensities of the primary colors employed. FIG. 4 illustrates a diagrammatic view of composing the plurality of color coordinate values in the color coordinate system of FIG. 3 to the encoded color signal of FIG. 2, wherein the red, green, and blue only have two color intensities which represent the coordinate value of 0 and 150, these three colors in each pixel are mixed with any one of the color intensities of 0 and 150 respectively.

At block 204, the device for encoding determines and selects a set of superposition codes. The sum of any one of the plurality of subsets of superposition codes is not equal to any one of the digits of the set of superposition codes, and the sum of any one of the plurality of subsets of superposition codes is not equal to the sum of the complementary set of the plurality of subsets of superposition codes. When selecting a plurality of digits of the set of superposition codes can form a set of color intensity codes, the numbers of the digits of the set of color intensity codes is less than or equal to the numbers of the digits of the set of superposition codes. For example, the set of superposition codes may be {1, 2, 4, 8, 16, 32, . . . }, corresponding to the set of color intensity codes may be {1, 2, 4, 8}, {4, 16, 32} or {1, 2, 4, 8, 16, 32}, the set of superposition codes may be {1, 3, 5, 7, 17, 34}, corresponding to the set of color intensity codes may be {1}, {1, 3, 5, 7, 17, 34} or {1, 34}. The sum of the set of color intensity codes corresponding to one of the plurality of color coordinate values in the color coordinate system. For example, the sum of the set of color intensity codes {1, 2, 4, 8} correspond to one of the plurality of color coordinate values 15 in the color coordinate system. Each digit of the set of superposition codes corresponds to each binary bit of a digitized color value. For example, the digitized color value 1111 corresponds to the set of color intensity codes {1, 2, 4, 8}, and the digits 1, 2, 4 and 8 of the set of color intensity codes {1, 2, 4, 8} correspond to the binary bits 1, 10, 100 and 1000 of the digitized color value 1111 respectively.

At block 206, the device for encoding selects the set of superposition codes for the color coordinate values of each pixel (the coordinate value of R axis, the coordinate value of G axis, the coordinate value of B axis) and composes the set of color intensity codes of each color coordinate value according to the digitized color value. For example, selecting the digits 1, 2, 8 from the set of superposition codes {1, 2, 4, 8} to compose the set of color intensity codes {1, 2, 8}.

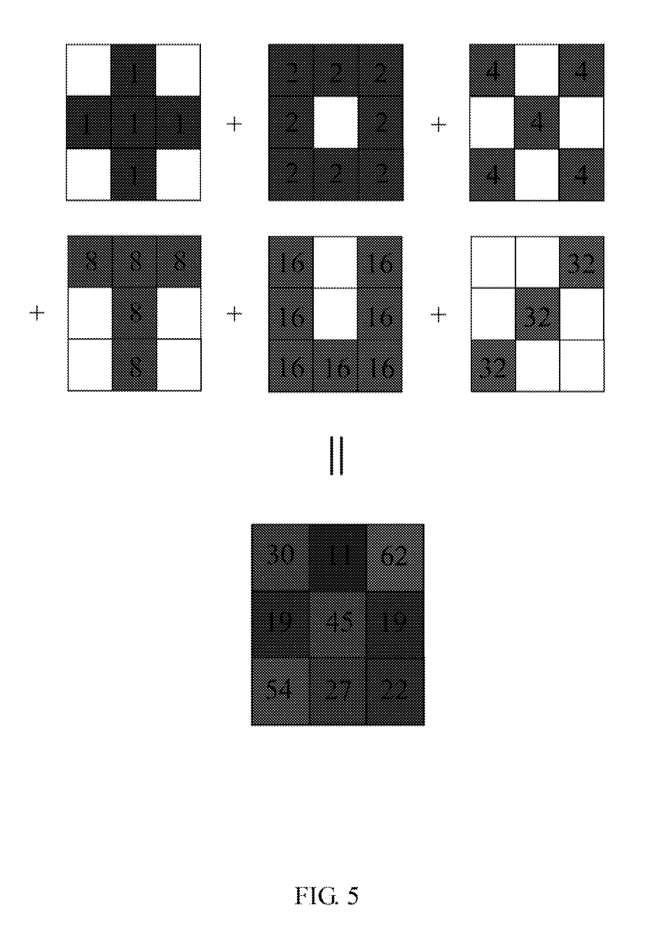

At block 208, the device for encoding obtains the color coordinate values of each pixel of the color signal by adding the digits of the set of color intensity codes. FIG. 5 illustrates a diagrammatic view of composing one or more digits of the set of superposition codes to the plurality of color coordinate values of FIG. 2. The set of color intensity codes is {2, 4, 8, 16}, the coordinate value of R axis of a first pixel corresponding to the set of color intensity codes is {2, 4, 8, 16} is 2+4+8+16=30. The set of color intensity codes is {1, 2, 8}, the coordinate value of R axis of a first pixel corresponding to the set of color intensity codes is {1.2.8} is 1+2+8=11, and so on.

At block 210, the device for encoding inputs the encoded color signal.

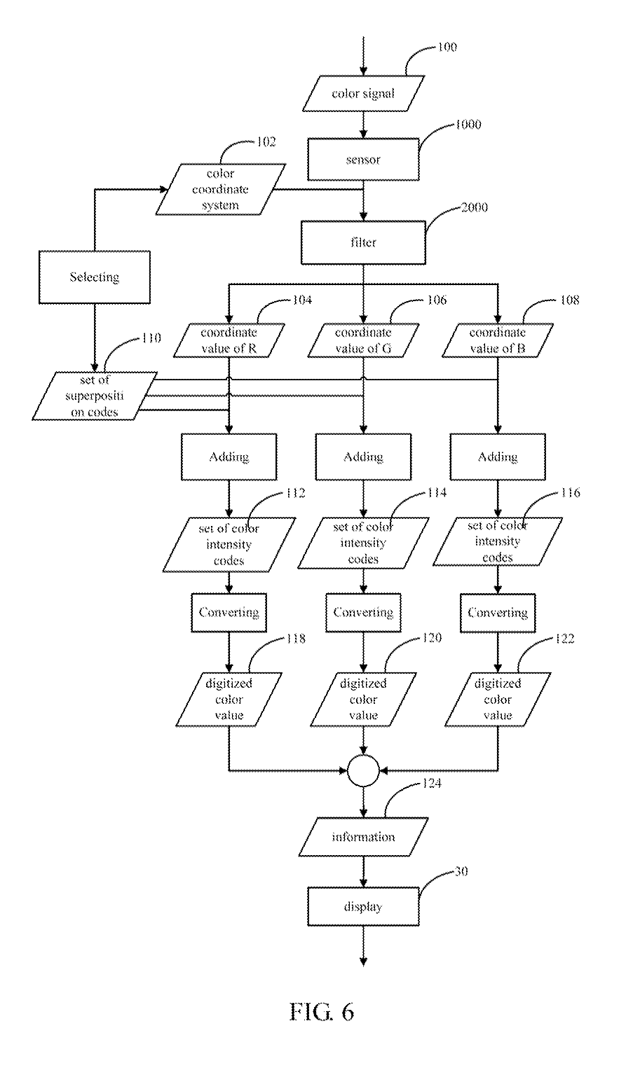

FIG. 6 illustrates a diagrammatic view of another embodiment of FIG. 1. After a sensor 1000 of a device for encoding receiving and inputting the encoded color signal 100 and a device for decoding selected color coordinate system 102 and a set of superposition codes 110, a filter 2000 of the devices for decoding decomposes the encoded color signal 100 in the color coordinate system to the coordinate value of R axis 104, the coordinate value of G axis 106 and the coordinate value of B axis 108 of each pixel, and decomposes the coordinate value of R axis 104, the coordinate value of G axis 106 and the coordinate value of B axis 108 of each pixel to a set of color intensity codes 112, 114, 116 according to the set of superposition codes 110 respectively. The devices for decoding converts the set of color intensity codes 112, 114, 116 to a digitized color value 118, 120, 122, the digitized color value 118, 120, 122 express the information 124 of each pixel together, and displays the information 124 in the display 30 by decoding.

Therefore, under the method for encoding and decoding color signals of the present disclosure, the amount of information contained in one color signal can reach (ÎM)̂K, where I=sum (C (i, y), y=0˜i)), i is the total number of digits of the set of superposition codes, M is the number of color coordinate values in the color coordinate system (e.g., the number of color coordinate values in the RGB coordinate system is 3), K is the number of dots of the matrix (i.e., the number of pixels) of the color signal. And if dots of the matrix only be 0 or 1, the amount of information only reach 2̂K. Thus, the amount of information greatly increases after using the method of the present disclosure.

While various embodiments of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A method for encoding and decoding color signals, the method comprising:
inputting an encoded color signal;
decomposing the encoded color signal in a color coordinate system to a plurality of color coordinate values;
decomposing each of the plurality of the color coordinate values to a set of color intensity codes, the codes comprising at least one digit, wherein a summation of the set of color intensity codes corresponds to each of the plurality of the color coordinate values, and each digit of the set of the color intensity codes corresponds to at least one digit of a set of superposition codes;
converting the set of color intensity codes to a digitized color value; and
outputting the digitized color code value.

2. The method of claim 1, wherein the color coordinate system is RGB coordinate system, the encoded color signal further comprises a matrix of a plurality of pixels, the plurality of pixels corresponds to a plurality of RGB values, and the plurality of RGB values corresponds to the plurality of color coordinate values.

3. The method of claim 1, wherein the summation of any one of a plurality of subsets of superposition codes is not equal to any one of the digits of the set of superposition codes, and the summation of any one of the plurality of subsets of superposition codes is not equal to the summation of a complementary set of the plurality of subsets of superposition codes.

4. The method of claim 1, wherein converting the set of color intensity codes to a digitized color value further comprises:
binary converting each digit of the set of the color intensity codes; and
converting the summation of each digit of the set of the color intensity codes to the digitized color value.

5. The method of claim 1, further comprises:
composing one or more digits of the set of color intensity codes to the plurality of color coordinate values; and
composing the plurality of color coordinate values in the color coordinate system to the encoded color signal.

6. The method of claim 5, wherein the color coordinate system is RGB coordinate system, the encoded color signal further comprises a matrix of a plurality of pixels, the plurality of pixels corresponds to a plurality of RGB values, and the plurality of RGB values corresponds to the plurality of color coordinate values.

7. The method of claim 5, wherein the summation of any one of a plurality of subsets of superposition codes is not equal to any one of the digits of the set of superposition codes, and the summation of any one of the plurality of subsets of superposition codes is not equal to the summation of a complementary set of the plurality of subsets of superposition codes.

8. The method of claim 5, wherein converting the set of color intensity codes to a digitized color value further comprises:
binary converting each digit of the set of the color intensity codes; and
converting the summation of each digit of the set of the color intensity to the codes digitized color value.

9. A method for decoding color signals comprising:
inputting an encoded color signal;
decomposing the encoded color signal on a color coordinate system to a plurality of color coordinate values;
decomposing each of the plurality of the color coordinate values to a set of color intensity codes, wherein the summation of the set of color intensity codes corresponding to each of the plurality of the color coordinate values, and each digit of the set of the color intensity codes corresponding to one of the digits of a set of superposition codes;
converting the set of color intensity codes to a digitized color value; and
outputting the digitized color code value.

10. The method of claim 9, wherein the color coordinate system is RGB coordinate system, the encoded color signal further comprises a matrix of a plurality of pixels, the plurality of pixels corresponding to a plurality of RGB values, and the plurality of RGB values corresponding to the plurality of color coordinate values.

11. The method of claim 9, wherein the summation of any one of a plurality of subsets of superposition codes is not equal to any one of the digits of the set of superposition codes, and the summation of any one of the plurality of subsets of superposition codes is not equal to the summation of a complementary set of the plurality of subsets of superposition codes.

12. The method of claim 9, wherein converting the set of color intensity codes to a digitized color value further comprises:
binary converting each digit of the set of the color intensity codes; and
converting the summation of each digit of the set of the color intensity to the codes digitized color value.

13. A method for encoding color signals comprising:
composing one or more digits of a set of color intensity codes to a plurality of color coordinate values; and
composing the plurality of color coordinate values in a color coordinate system to an encoded color signal.

14. The method of claim 13, wherein the color coordinate system is RGB coordinate system, the encoded color signal further comprises a matrix of a plurality of pixels, the plurality of pixels corresponding to a plurality of RGB values, and the plurality of RGB values corresponding to the plurality of color coordinate values.

15. The method of claim 13, wherein the summation of any one of a plurality of subsets of superposition codes is not equal to any one of the digits of the set of superposition codes, and the summation of any one of the plurality of subsets of superposition codes is not equal to the summation of a complementary set of the plurality of subsets of superposition codes.
